(19) United States
(12) Patent Application Publication
(10) Pub. No.: US 2002/0097428 A1
(43) Pub. Date: Jul. 25, 2002

(54) Methods and systems for print job interleaving

(76) Inventor: Andrew R. Ferlitsch, Tigard, OR (US)

Correspondence Address: Scott C. Krieger, Patent Counsel, Sharp Laboratories of America, Inc., 5750 NW Pacific Rim Boulevard, Camas, WA, 98607, US

(21) Appl. No.: 10/002,781

(22) Filed: Oct. 29, 2001

Related U.S. Application Data
(60) Provisional application No. 60/261,132, filed on Jan. 11, 2001.

(51) Int. Cl. G06F 15/00; B41J 1/00

(52) U.S. Cl. 358/1.15

(57) ABSTRACT

The embodiments of the present invention comprise methods and systems for interleaving print jobs to avoid print job delay.

### RELATED REFERENCES

This application claims the benefit of Provisional Application Serial No. 60/261,132, entitled “Methods and Systems for Print-Processor Modified Printing” filed Jan. 11, 2001 by inventors Ferlitsch et al; this application also claims the benefit of U.S. patent application Ser. No. 09/681,208, entitled “Methods and Systems for Print-Processor Modified Printing” filed Feb. 22, 2001 by inventors Ferlitsch et al; this application further claims the benefit of U.S. patent application Ser. No. 09/894,928, entitled “Methods and Systems for Page-Independent Spool File Sheet Assembly” filed Jun. 28, 2001 by inventor Ferlitsch.

### BACKGROUND

In a typical shared printer environment, such as a network, print jobs from many sources may be sent to a single printer. Print jobs are generally queued in serial order based on time of arrival at the print queue. In these systems, the first print job received is the first print job completed in a first-in, first-out (FIFO) order. Although some systems may allow user manipulation of print queue order, the FIFO order is typically the default order regardless of print job size or other parameters.

Problems can occur in a FIFO order queue when print jobs of varying sizes are sent to the queue. Large print jobs can cause significant delay to subsequent print jobs. This can be particularly inconvenient and frustrating when a small print job follows a very large job by just a few seconds. For example, a 1000 page print job being printed on a high-end laser printer at 50 ppm will take approximately 20 minutes. If a single page letter is printed immediately following the 1000 page job, the person printing the letter must wait 20 minutes until the large 1000 page job is complete in order to get the single page letter.

Some existing systems use a priority designation for print jobs. These systems allow a user to assign a priority designation that determines the order in which print jobs will be printed. Priority may be automatically assigned based on print job characteristics such as file size, etc. Typically, smaller print jobs receive priority over larger print jobs to avoid the delay of the larger jobs. However, these systems also have problems particularly when large quantities of small jobs are sent to the print queue. In this situation, a large print job would be moved to the back of the print queue behind smaller, higher-priority print jobs. As new, smaller jobs enter the queue, they are also moved ahead of the lower-priority large job. If the smaller jobs continue to enter the queue, the large job may be delayed for an unacceptable period of time. This situation may be referred to as “starvation.”

Some priority-based systems use a graduated preference factor or graduated priority whereby the priority of a job is gradually increased over time. As higher-priority jobs pass a large, low-priority print job in the queue, its priority is increased until its priority is equal to that of the smaller jobs in the queue at which point the large job progresses down the queue to the printer. However, when the large job starts to print, the smaller jobs will again be delayed for a significant period.

These systems also suffer in a situation where the large print job begins printing before a smaller job arrives. In this situation, the larger job must be completed before another job can begin.

### SUMMARY

The systems and methods of embodiments of the present invention allow print jobs to be interleaved to avoid prolonged delay of particular print jobs. These embodiments allow print jobs to be interleaved into other print jobs based on priority, size or other factors. Interleaved print jobs may use different output mode options to uniquely identify each job's pages.

### BRIEF DESCRIPTION OF THE DRAWINGS

A more particular description of the invention, briefly described above, will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram depicting a typical print system in printer-ready data mode processing a first print job;

FIG. 2 is a diagram depicting a typical print system in printer-ready data mode processing a second print job;

FIG. 3 is a diagram depicting the serial print order of a typical print system;

FIG. 4 is a diagram depicting a typical print system in journaled mode processing a first print job;

FIG. 5 is a diagram depicting a typical print system in journaled mode processing a second print job;

FIG. 6 is a diagram depicting an embodiment of the present invention processing multiple printer-ready data print jobs;

FIG. 7 is a diagram depicting an embodiment of the present invention processing multiple journaled mode print jobs; and

FIG. 8 is a diagram of an embodiment of the present invention depicting the print sequence of an interleaved logical print job.

### DETAILED DESCRIPTION

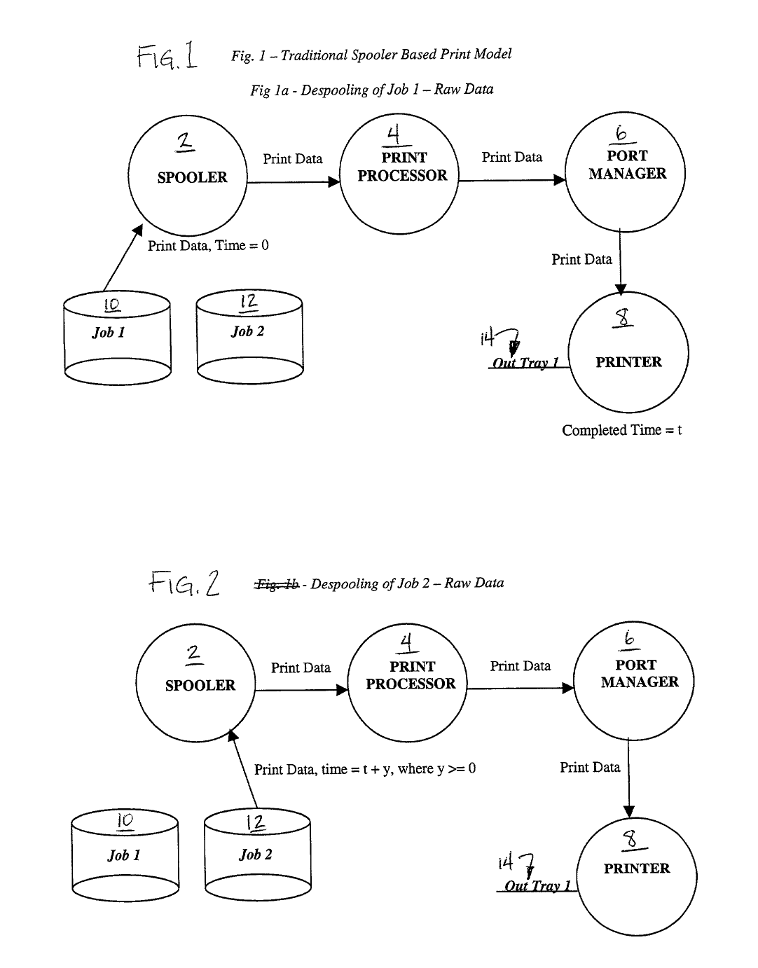

The figures listed above are expressly incorporated as part of this detailed description. It will be readily understood that the components of the present invention, as generally described and illustrated in the figures herein, could be arranged and designed in a wide variety of different configurations. Thus, the following more detailed description of the embodiments of the systems and methods of the present invention, as represented in FIGS. 1 through 8 is not intended to limit the scope of the invention, as claimed, but is merely representative of the presently preferred embodiments of the invention. Some embodiments of the present invention will be best understood by reference to the drawings, wherein like parts are designated by like numerals throughout.

The systems and methods of embodiments of the present invention typically comprise one or more printing devices, which may be connected locally, through a network or through a remote printing environment. These systems and methods may further comprise a computing device capable of generating or transmitting a print job to a printing device or transmitting the location of a print job to a printing device as in “pull printing.” These embodiments may also comprise a printer driver, a spooler, a print processor and other print system components that process, transmit or otherwise function to produce a print job. In some embodiments, these components may exist in a Microsoft Windows 9x, NT, 2000, XP or similar operating system. Details of these operating system print system components and processes may be obtained by reference to the Microsoft Windows Driver Development Kits (DDKs) and associated documentation, which are hereby incorporated herein by reference.

Embodiments of the present invention which utilize a Microsoft Windows® operating system generally comprise a printer driver, spooler, print processor and other print system components which process print tasks generated through the operating system and applications running on the operating system. Embodiments used in conjunction with other operating systems will utilize print system components with similar functions, which may be referred to by the terms used in Microsoft systems.

Exemplary embodiments of the present invention will be described with terminology related to a Microsoft Windows® environment, however these terms shall relate to equivalent elements in other operating systems. For example, the print processor described in many embodiments will relate to a print processor common in the Windows® environment as well as elements with equivalent functions in other operating systems.

The definitions in this and subsequent paragraphs apply throughout this specification and related claims. The term “print job” may refer to any combination of data that can be printed. A print job may comprise text and/or graphics and may comprise part of a page, a single page or many pages. Print jobs may be rendered or un-rendered. Generally, a print job is generated by an application, such as a word processor, spread sheet, etc., however, a print job may also comprise a file or data in memory that may be sent directly to a print process.

The term “network” may refer to any combination of computing devices and peripherals, such as printing devices, wherein the devices can communicate with each other. The term “network” may comprise Local Area Networks (LANs), Wide Area Networks (WANs) and many other network types. A network may be connected using conventional conductive cable, fiber-optic cable, phone line cable, power line cable or other electrical and light conductors and other signal transmission media as well as wireless connections using infrared, RF or other wireless methods.

To simplify discussion of a printing system used under a Microsoft Windows operating system, some groups of system components may be referred to collectively. Some components may also be referred to generically by their group name. For example, a spooler API server may be referred to as a spooler. A group of components comprising a spooler client interface, spooler API server, router, print job creation API and job scheduling API may be referred to as a spooler in a Windows NT/2000 operating system. A group of components comprising a language monitor, port monitor and port driver stack may be referred to as a port manager. A group of components comprising a file format director and EMF print processor DLL may be referred to as a print processor. Equivalent component groups may be referred to by these terms also whether in a Microsoft operating system or another system.

References to a Microsoft Windows or Windows operating system may refer to any version or variation of a Microsoft Windows operating system comprising Windows 95, Windows 98, Windows NT, Windows 2000, Windows ME, Windows XP and others. While exemplary embodiments of the present invention may be directed to a Windows operating system and environment, systems and methods directed to other operating systems such as Macintosh, UNIX, DOS, Linux, MVS and others are to be contemplated within the scope of the present invention.

Embodiments of the present invention may be embodied in software, firmware, hardware and other forms that achieve the function described herein. As embodiments of the present invention may be adapted to many environments with varying computing devices, operating systems, printing devices, network hardware and software, applications and other variables, these embodiments may take many forms to achieve their function. Some embodiments may also be transmitted as signals, for example, and not by way of limitation, embodiments may be transmitted as analog or digital electrical signals or as light in a fiber-optic line. All of these embodiments are to be considered within the scope of the present invention.

In a typical printing environment, a user may initiate a print job, which generally comprises a single document generated by an application that is to be printed. In some embodiments of the present invention, a user may also initiate a print task, which may comprise one or more documents consisting of one or more pages each. A print task may also comprise multiple copies of a print job. A print job or task may be pre-processed into printer-ready data, such as output in a Page Description Language (PDL) such as Print Command Language (PCL), Adobe Postscript, Portable Document Format (PDF) and Tagged-Image File Format (TIFF) as non-limiting examples. A print job or task may also be journaled. In a journaled print job or task, rendering instructions are recorded for subsequent playback. Some examples of journaled formats are Enhanced Metafile (EMF) and Sharp's Printer Meta file (PMF).

Generally, when a print job or task is initiated, a user makes an input selection to initiate the process. The computing device may respond with the display of a dialog such as a print dialog box, a command line query, a panel display or some other form of user interface that allows a user to select print task options. One option may be the selection of the printing device such as a printer, plotter, Multi-Function Peripheral (MFP), CD burner or other device. Once the printing device is selected, a driver and, optionally, a print processor and other print system components may be loaded. Once the driver and/or other print system components are loaded, an additional dialog may be presented to prompt a user of options available on the selected device. Options such as print quality, paper size, orientation, tray selection, manual feed, stapling, watermarks, cluster printing, pool printing and other options may be selected.

In some embodiments of the present invention, print system components may present the user with a dialog that provides print job or print task interleaving options. Other embodiments may automatically select interleaving options for print jobs or tasks.

Once printing options have been selected or otherwise established, either manually or automatically, print job or task processing may commence. Print job or task processing may comprise construction of print job or print task specific information by the printer driver. This may comprise device initialization and environment data such as DEVMODE data in a Microsoft Windows environment. Rendering instructions are then compiled and either recorded for deferred playback (journaled data) or processed into printer-ready data. In some cases, a print task may be partially or wholly rendered into printer-ready data in a previous step and the compilation of rendering instruction may be skipped or partially skipped.

The output from a print driver, in a spooled print environment, may be referred to as a spool file and its contents may be referred to as spool data. A spool file may be recorded on disk, in memory, in cache or other storage media compatible with a computing device. In embodiments of the present invention, a spool file may comprise interleaving data. Interleaving data may comprise printer output mode options such as, but not limited to, output tray options, output page orientation, output page location, media selection or other criteria affecting aspects of printing device output.

When the spool file is complete, control is passed from the driver to another print system component. In some systems, control is passed to a print processor, which may determine whether the data is in a printer-ready format and process the data accordingly. If the data is in a printer-ready format, it may be sent to the port of the selected printing device. If the data is journaled, it may be further processed into a printer-ready format. This process may be referred to as spooling as the data is spooled from the spool file to its destination. Once journaled data is processed into printer-ready data, it may be despooled to the port associated with its destination printing device.

### Printer-Ready Mode Print Process

In a typical known print spool subsystem as shown in FIGS. 1 through 3, when two printer-ready print jobs, such as Raw mode print jobs 10 & 12, arrive at a spooler 2 at approximately the same time, the spooler 2 selects the print job 10 that arrived first for processing. In a typical Microsoft Windows operating system, the spool data is sent from the spooler 2 to the print processor 4 for processing and transmitting to other print system components. When processing is complete, the print data is sent to port manager 6 and relayed to printer 8. Printer 8 remains occupied with this first print job 10 until its resources are freed up for another print job.

Printer 8 may comprise a hard drive, memory or other storage capability as well as processing and spooling capabilities. Printer 8 may have the capability to process and store and/or print one print job while the operating system despools another print job to printer 8. In this situation, a second print job 12 may be despooled to printer 8 before printer 8 completes a first print job 10. However, the print jobs are still printed in serial order and a user must wait for the first print job 10 to complete before printing the second print job 12.

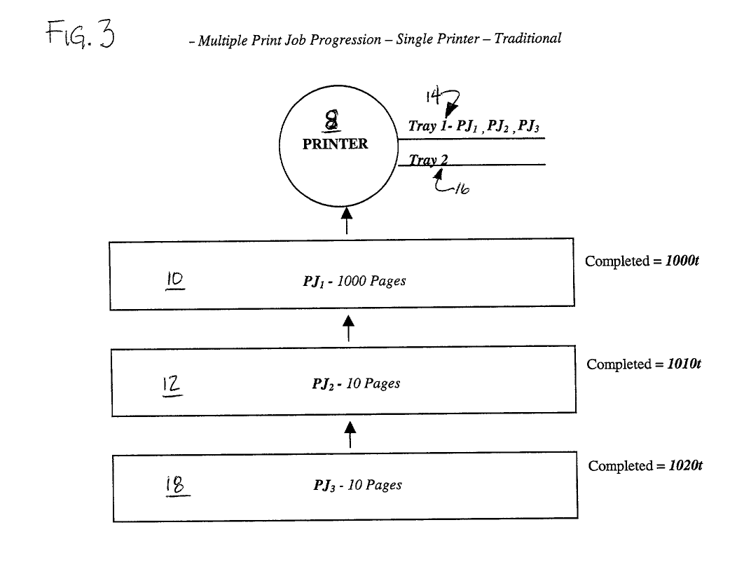

When printer 8 resources are freed up, as shown in FIG. 2, the second print job 12 may be despooled to port manager 6 and relayed to printer 8. Printer 8 will remain occupied until its resources are freed from processing and printing the second print job 12.

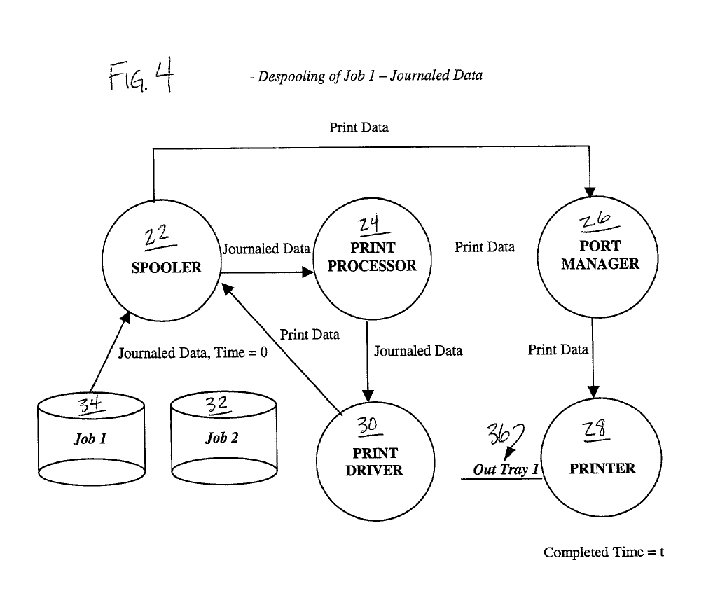

When resources are freed from the second print job 12, the printer 8 is ready to accept a third print job 18 as shown in FIG. 3. It should be noted that these first, second and third print jobs are printed serially in a first in-first out (FIFO) order requiring each print job to be delayed while prior print jobs are printing. When the first print job is large, this results in significant delay for the subsequent jobs.

### Journaled Mode Print Process

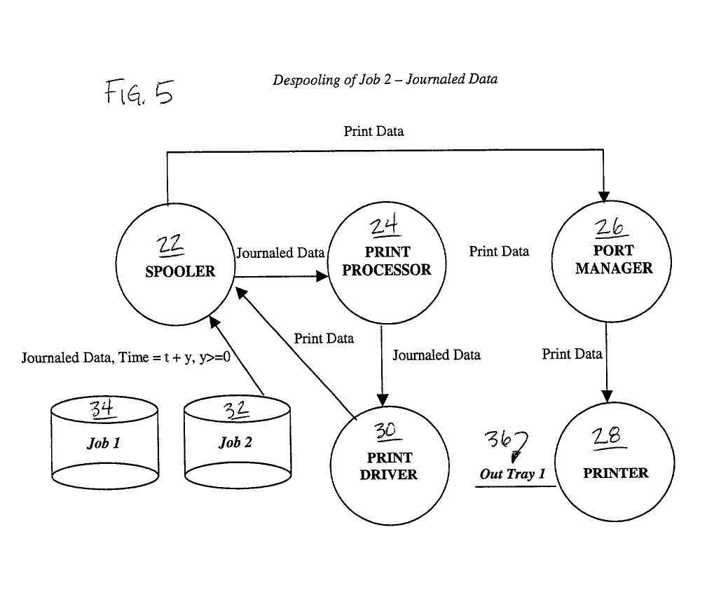

Another typical, known print spool subsystem is shown in FIGS. 4 and 5 where a journaled mode print process is illustrated. In this system, when two journaled data print jobs, such as EMF mode print jobs 32 & 34, arrive at a spooler 22 at approximately the same time, the spooler 22 selects the print job 34 that arrived first for processing. In a typical Microsoft Windows operating system, the spool data is sent from the spooler 22 to the print processor 24 for processing and transmitting to other print system components. When a print processor 24 receives a journaled mode print job, print processor 24 directs the print job to print driver 30 for conversion to a printer-ready format. Once converted by driver 30 and any associated components such as a graphical device interface (GDI) or other components, the converted print job is sent back to spooler 22 for despooling. The converted data is despooled to a port manager 26 that is associated with a destination printer 28. The port manager 26 directs the print job to printer 28 for printing. Printer 28 remains occupied with this first print job 34 until its resources are freed up for another print job.

Printer 28 may comprise a hard drive, memory or other storage capability as well as processing and spooling capabilities. Printer 28 may have the capability to process and store and/or print one print job while the operating system despools another print job to printer 28. In this situation, a second print job 32 may be despooled to printer 28 before printer 28 completes a first print job 34. However, the print jobs are still printed in serial order and a user must wait for the first print job 34 to complete before printing the second print job 32.

When printer 28 resources are freed up, as shown in FIG. 5, the second print job 32 may be processed by print processor 24, driver 30 and associated print system components before being despooled to port manager 26 and relayed to printer 28. Printer 28 will remain occupied until its resources are freed from processing and printing the second print job 32.

When resources are freed from the second print job 32, the printer 28 is ready to accept a third print job 18 as shown in FIG. 3 which represents both printer-ready and journaled mode systems. It should be noted again that these first, second and third print jobs are printed serially in a first-in-first-out (FIFO) order requiring each print job to be delayed while prior print jobs are printing. When the first print job is large, this results in significant delay for the subsequent jobs.

### Print Job Interleaving - Printer-Ready Data

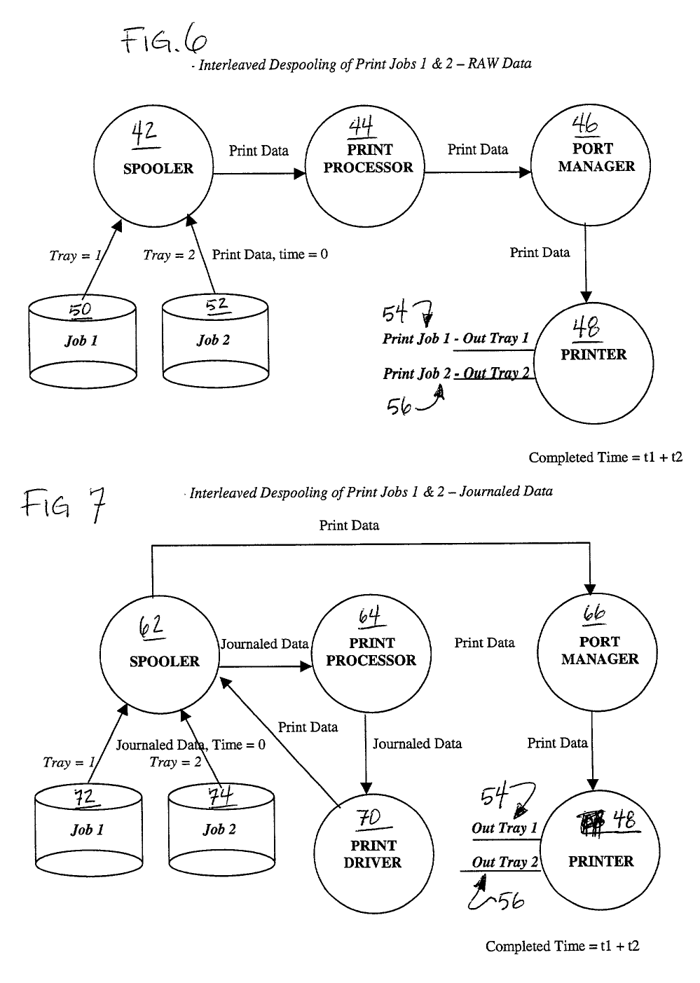

In some embodiments of the present invention, as illustrated in FIG. 6, when two or more printer-ready data print jobs arrive at an interleaving print system component, such as an interleaving spooler 42, the spooler 42 or similar print system component creates a logical print job by opening and holding open a connection to a printer 48. All print jobs 50 & 52, regardless of the order in which they arrive, are broken down into print sub-jobs. Print job breakdown may be based on a print jobs number of pages, file size, page description language (PDL), page format, finishing requirements, media type and size, resolution or other decomposable factors. The partitions, which split a print job into sub-jobs, may be fixed or variable. The size of the sub-jobs may be user selected, administrator selected or otherwise selected. Sub-job size may also be determined dynamically by a spooler or other print system component. Sub-jobs may be partitioned according to factors comprising file size, printing time or other factors such as those listed above.

Once sub-jobs are partitioned, the sub-jobs are interleaved into a single logical print job by alternating sub-jobs from separate print jobs. Each print job is distinguished from others by its output mode. Output modes may comprise a printer tray destination, printer tray offset, page orientation, media type, media size or other criteria that can be used to distinguish printer output. Each sub-job sent to the printer is tagged with an output mode code that identifies the print job from which the sub-job originated. For example, a one-hundred-page job and a 3-page job may be printed virtually simultaneously in an interleaved process on a printer with two output modes such as two output trays 54 & 56. In this scenario, the first ten pages of the one-hundred-page job may comprise a sub-job that is printed and output to a first output tray 54. The next sub-job may be the 3-page document, which is printed after the first ten pages of the one-hundred-page document and output to a second output tray 56. Subsequent sub-jobs may comprise the remaining portions of the one-hundred-page document, which are sent to the first output tray 54. The result is that the 3-page job is only marginally delayed by the larger job and can be separated from the larger job by its output mode, in this case the separate output tray.

If all the sub-jobs of a first print job are interleaved into a master logical print job before a second, larger print job is expended, other sub-jobs from other print jobs may be interleaved into the logical print job. Accordingly, if a continuous stream of print jobs arrives at an interleaving print system component, a single logical print job can be constructed that will continue until the stream of print jobs ends.

When multiple output trays are not available, other output modes may be used, for example and not by way of limitation, the output position in a single output tray may be varied, the page orientation may be varied for each print job, as well as other output mode options.

Print job interleaving may be performed by a print system component, such as spooler 42, print processor 44 or some other component or sub-component in the print system. These inventive print system components may reside on a client machine, on a network server, such as in operative print queue components, on a printing device or some other location in a print system. Some embodiments may take the form of printing device firmware, such as in a firmware spooler in an MFP or other printing device.

### Print Job Interleaving - Journaled Data

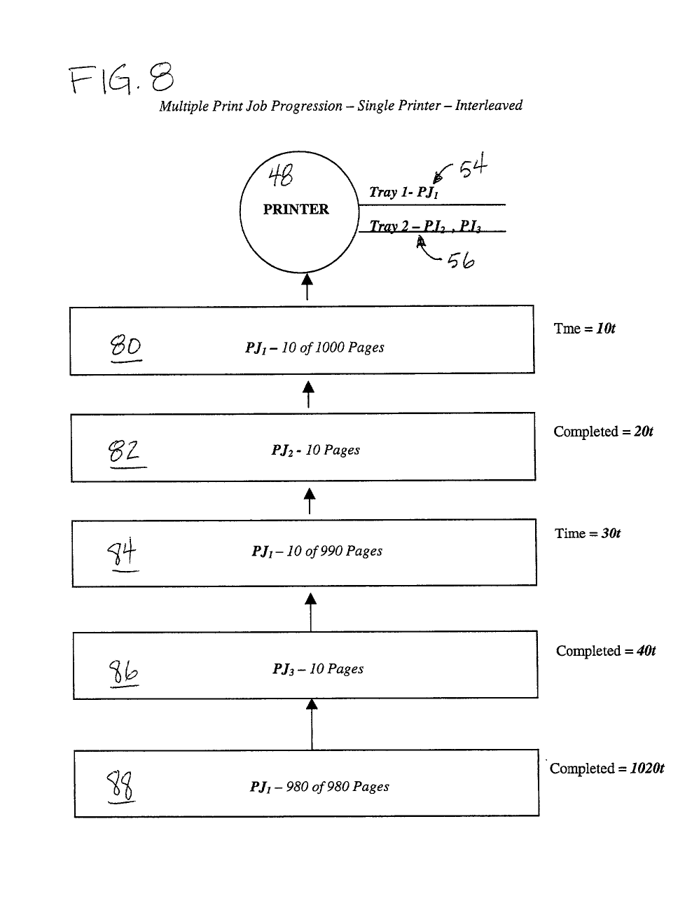

Some embodiments of the present invention, shown in FIG. 7, operate in conjunction with journaled print jobs. In these illustrative embodiments, two or more journaled print jobs may arrive at an interleaving print system component such as spooler 62, print processor 64, driver 70 or some other print system component or sub-component. When these journaled print jobs arrive at the interleaving print system component, the interleaving component or a related component creates a logical print job by opening and holding open a device context (DC) for printing to the printer driver 70 associated with the destination printer 48. All print jobs, regardless of their arrival order, are broken down into sub-jobs according to an algorithm or scheme which may or may not comprise user input and control. This process may be based on the number of pages in a print job, printing time, file size or some other factor such as those explained earlier for other embodiments. Sub-jobs may have a fixed size or may be variable in size. Sub-job size may be selected by a user, an administrator or selected in some other manner. Sub-job size may also be determined dynamically.

Once sub-jobs are created, the interleaving component(s) may interleave the sub-jobs of a plurality of print jobs into a single master logical print job in some alternating sequence. The sequence may be a simple rotation between print jobs in the order they arrived or may be some other sequence based on print job parameters such as print job size, print time, processing requirements or some other factor.

Each print job is distinguished from others by its output mode. Output modes may comprise a printer tray destination, printer tray offset, page orientation, media type, media size or other criteria that can be used to distinguish printer output. Each sub-job sent to the printer is tagged with an output mode code that identifies the print job from which the sub-job originated.

In embodiments that work in conjunction with journaled print jobs, a print job may be broken down at various points in the print stream. Journaled print jobs 72 & 74 first arrive at the spooler 62, which may break the job down into journaled sub-jobs or send the unmodified print job to print processor 64, which will direct the print job to print driver 70, which, in conjunction with other print system components, such as a graphics device interface (GDI) will convert the journaled print job into a printer-ready format and send the printer-ready job back to spooler 62. If the print job has not previously been broken down into sub-jobs at this point, an interleaving spooler 62 may break down the printer-ready print jobs into printer-ready sub-jobs and interleave the sub-jobs into a master logical print job. The logical print job may then be despooled to the port manager 66 and sent to the destination printer 48. When the print sub-jobs are output from printer 48, each original print job will be output in a different output mode. In a simple example, each original print job will be output to a different output tray. In more complicated scenarios, each original print job may be output with a different tray offset, page orientation, media size, media type or other output mode.

An original print job may be broken down into sub-jobs at various points in the print stream. In some embodiments, an interleaving spooler 62 will break down the jobs, in others an interleaving print processor 64 may perform break down functions. Other print system components may also perform original job break down functions.

A non-limiting example of the processes of some embodiments of the present invention is illustrated in FIG. 8, which shows the makeup of an interleaved logical print job. In this example, a first original print job consisting of 1000 pages, a second original print job consisting of 10 pages and a third original print job consisting of 10 pages are sent to an interleaving print system component. This interleaving component breaks down each original print job into sub-jobs of 10 pages per sub-job. These sub-jobs are interleaved into a logical print job that is despooled to a printer 48 with two output trays 54 & 56.

The first sub-job 80 to arrive at the printer 48 contains the first ten pages of the first original print job. The second sub-job 82 to arrive at printer 48 contains the entirety of the second original print job. The third sub-job 84 to arrive at printer 48 contains the second ten pages of the first original print job. The fourth sub-job 86 to arrive at printer 48 contains the entirety of the third original print job. These sub-jobs are followed by sub-jobs 88 containing the remaining portions of the first print job.

It can be readily understood that the vast majority of the delay that would have been caused if the second and third original print jobs had to wait for the complete printing of the first original print job has been averted. The second original print job is completed at time 20t and the third original print job is completed at time 40t. Both of the second and third original print jobs would have been completed at times 1010t and 1020t, respectively, without the interleaving processes of embodiments of the present invention.

Sub-jobs may be partitioned according to a variety of factors. Typically, these factors will be chosen in order to minimize print delays and maximize printing speed. Some factors that can be used to influence sub-job partitioning may comprise: 1) the page description language (PDL); 2) print job page formatting, such as duplex printing; 3) print job finishing requirements; 4) print job paper size or orientation; 5) the resolution of the print job; 6) graphic content; 7) color content and/or other factors.

In some embodiments, sub-jobs may be partitioned according to the amount of time required to print each sub-job. Each sub-job may have a print time that is substantially equal to the other sub-jobs. In these embodiments, the number of pages in each sub-job may vary by a large margin, particularly when some sub-jobs comprise detailed, high-resolution graphics.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for interleaving print jobs comprising:
selecting a plurality of original print jobs for printing;
breaking down said original print jobs into smaller sub-jobs;
interleaving said sub-jobs in an alternating sequence; and
printing said sub-jobs in said sequence.

2. The method of claim 1 wherein said selecting, said breaking down and said interleaving are performed at a client computing device.

3. The method of claim 1 wherein said selecting, said breaking down and said interleaving are performed at a server.

4. The method of claim 1 wherein said selecting, said breaking down and said interleaving are performed at a printing device.

5. The method of claim 1 wherein said breaking down is performed by a print system component.

6. The method of claim 5 wherein said print system component is a print processor.

7. The method of claim 5 wherein said print system component is driver independent.

8. The method of claim 5 wherein said print system component is a spooler.

9. The method of claim 5 wherein said print system component is a driver.

10. The method of claim 1 wherein said breaking down results in sub-jobs of approximately equal size.

11. The method of claim 1 wherein said breaking down results in sub-jobs of approximately equal printing time.

12. The method of claim 1 wherein said alternating sequence places sub-jobs originating from smaller original print jobs toward the front of the print order.

13. A method for interleaving print jobs comprising:
receiving a plurality of original print jobs at a print system component;
breaking down said original print jobs into smaller sub-jobs;
interleaving said sub-jobs in an alternating sequence; and
printing said sub-jobs in said sequence.

14. A method for reducing delay of smaller print jobs in a print queue, said method comprising:
receiving a plurality of original print jobs at a print system component, said plurality of original print jobs comprising at least one larger print job and at least one smaller print job;
breaking down said larger original print job into smaller sub-jobs;
interleaving said sub-jobs with said smaller original print job in an alternating sequence; and
printing said sub-jobs and said smaller original print job in said sequence.

15. The method of claim 14 further comprising breaking down said smaller original print job into smaller sub-jobs and wherein said interleaving comprises interleaving said smaller sub-jobs from said larger print job with said smaller sub-jobs from said smaller print job.

16. A system for interleaving print jobs comprising:
a receiver for receiving a plurality of original print jobs;
a partitioner for breaking down said original print jobs into smaller sub-jobs; and
an interleaver for interleaving said sub-jobs in an alternating sequence.

17. A computer readable medium comprising instructions for performing functions within a print system component, said instructions comprising the acts of:
receiving a plurality of original print jobs at a print system component;
breaking down said original print jobs into smaller sub-jobs;
interleaving said sub-jobs in an alternating sequence; and
printing said sub-jobs in said sequence.

18. A computer data signal embodied in an electronic transmission, said signal having the function of interleaving print jobs, said signal comprising instructions for:
receiving a plurality of original print jobs at a print system component;
breaking down said original print jobs into smaller sub-jobs;
interleaving said sub-jobs in an alternating sequence; and
printing said sub-jobs in said sequence.
